(19) United States
(12) Patent Application Publication
(10) Pub. No.: US 2026/0261375 A1
(43) Pub. Date: Sep. 3, 2026

(54) POLARIZATION CONFIGURATION FOR UPLINK REFERENCE SIGNALS

(71) Applicant: Lenovo (Singapore) Pte. Limited, Singapore (SG)

(72) Inventors: Sher Ali Cheema, llmenau (DE); Robin Rajan Thomas, Bad Nauheim (DE); Vijay Nangia, Woodridge, IL (US)

(73) Assignee: Lenovo (Singapore) Pte. Limited, Singapore (SG)

(21) Appl. No.: 19/154,481

(22) PCT Filed: Feb. 15, 2024
(86) PCT No.: PCT/IB2024/051435

§ 371 Date: Aug. 7, 2025

Related U.S. Application Data
(60) Provisional application No. 63/485,101, filed on Feb. 15, 2023.

(51) Int. Cl. H04L 5/00; H04L 27/26

(52) U.S. Cl. CPC H04L 5/0044; H04L 5/0005; H04L 27/261

(57) ABSTRACT

Various aspects of the present disclosure relate to an apparatus for polarization configuration for uplink reference signals. The apparatus, such as a user equipment (UE), transmits a first signaling including one or more polarization parameters for signal reception and signal transmission. The UE receives a second signaling as a configuration for uplink reference signals, where the configuration includes an association of time and frequency resources with at least one polarization type based on the one or more polarization parameters. The UE transmits the uplink reference signals according to the configuration.

### RELATED APPLICATION

This application claims priority to U.S. Provisional Application Ser. No. 63/485,101 filed Feb. 15, 2023 entitled “Polarization Configuration for Uplink Reference Signals,” the disclosure of which is incorporated by reference herein in its entirety.

### TECHNICAL FIELD

The present disclosure relates to wireless communications, and more specifically to uplink reference signals configuration.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, multiple polarization types, such as linear polarization, left-hand circular polarization (LHCP), and right-hand circular polarization (RHCP) are usable for data channels in a non-terrestrial network (NTN). A polarization type can be indicated by the network in NTN system information block (SIB) for downlink and uplink data signals. However, the typical use of polarization is primarily an optional feature and has limited functionality, given that use of polarization is dependent on a UE ability to support a polarization type for data transmission and reception. Some UEs are capable of transmitting multiple polarizations simultaneously, while other UEs may have the support for multiple polarizations, but do not transmit or receive simultaneously.

### SUMMARY

The present disclosure relates to methods, apparatuses, and systems that support polarization configuration for uplink reference signals. By utilizing the described techniques, a UE can indicate its capability to support reception and transmission of signals with one or multiple polarization types, where this indication may be either an explicit request from the network or indicated by default. The UE can not only indicate its capability to support one or multiple polarization types, but can also indicate other polarization related parameters so that the network may configure uplink and downlink resources accordingly. Additionally, sounding reference signal (SRS) resources are mapped in the polarization domain, in addition to frequency and time domain. The network (e.g., a location-management function implemented by a network entity) can configure resources for uplink reference signals, such as SRS, in the polarization domain and this configuration relates a polarization type to a SRS-identifier (ID), to a SRS resource set ID, or at cell level.

Further, the uplink reference signals, such as SRS, are repeated in the polarization domain to enhance the coverage, where repetitions may use polarization diversity or polarization multiplexing schemes. In one or more implementations, the repetition of SRS may be enhanced in the polarization domain, where in addition to frequency domain repetitions, the SRS is repeated in the polarization domain (e.g., transmitting the SRS symbol using two circular polarization types (LHCP and RHCP)). The multiplexing of SRS with other uplink channels (e.g., physical uplink shared channel (PUSCH), physical uplink control channel (PUCCH)) or other SRS resources may be carried out in the polarization domain, where the other uplink channels may use one type of polarization, while SRS would use another, different type of polarization. A polarization type can be used, selected, or indicated for uplink link adaptation for codebook and non-codebook based uplink transmission, where in addition to SRS resource indicator (SRI), rank indicator (RI), and transmit precoding matrix indicator (TPMI), a polarization type (e.g., Pol-UL) is also indicated by the network for PUSCH data transmission.

In some implementations of the method and apparatuses described herein, a UE transmits a first signaling including one or more polarization parameters for signal reception and signal transmission. The UE receives a second signaling as a configuration for uplink reference signals, the configuration including an association of time and frequency resources with at least one polarization type based at least in part on the one or more polarization parameters. The UE transmits the uplink reference signals according to the configuration.

Some implementations of the method and apparatuses described herein may further include the UE receives a third signaling as a reporting configuration of a request to indicate a polarization capability of the apparatus. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported by the apparatus. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with a network entity.

Additionally, the configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The UE transmits a third signaling as an indication of a polarization type used for uplink resources in uplink control information (UCI) or in uplink medium access control element (MAC CE). The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

In some implementations of the method and apparatuses described herein, a gNB receives, from a UE, a first signaling including one or more polarization parameters for signal reception and signal transmission. The gNB transmits, to the UE, a second signaling as a configuration for uplink reference signals, the configuration including an association of time and frequency resources with at least one polarization type based at least in part on the one or more polarization parameters.

Some implementations of the method and apparatuses described herein may further include the gNB transmits, to the UE, a third signaling as a reporting configuration of a request to indicate a polarization capability of the UE. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported by the apparatus. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with the UE.

Additionally, the configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The gNB receives, from the UE, a third signaling as an indication of a polarization type used for uplink resources in UCI or in uplink MAC CE. The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

### BRIEF DESCRIPTION OF THE DRAWINGS

FIG. 1 illustrates an example of a wireless communications system that supports polarization configuration for uplink reference signals in accordance with aspects of the present disclosure.

FIG. 2 illustrates an example of a SRS-Config information element (IE), which supports polarization configuration for uplink reference signals in accordance with aspects of the present disclosure.

FIGS. 3 and 4 illustrate an example of a block diagram of devices that supports polarization configuration for uplink reference signals in accordance with aspects of the present disclosure.

FIGS. 5-8 illustrate flowcharts of methods that support polarization configuration for uplink reference signals in accordance with aspects of the present disclosure.

### DETAILED DESCRIPTION

A wireless communications system includes UEs, some of which are capable of transmitting multiple polarizations simultaneously, while other UEs may have the support for multiple polarizations, but do not transmit or receive simultaneously. Notably, current specifications do not support an indication of UE capabilities to support a polarization type and related parameters. Multiple polarization types, such as linear polarization, LHCP, and RHCP are usable for data channels in a NTN. However, the typical use of polarization is primarily an optional feature and has limited functionality, given that use of polarization is dependent on a UE ability to support a polarization type for data transmission and reception. Generally, it is up to a UE to use one of the polarization types based on its capability, which may however result in polarization mismatch errors, thus reducing the link budget. Moreover, the current specifications do not discuss mapping or a configuration of a polarization type as an additional domain, which can be used to enhance the overall system capacity. Specifically, the use of circular polarization types (i.e., LHCP and RHCP) adds another dimensionality to generate orthogonal signals, while also significantly improving the frequency usage efficiency.

In aspects of polarization configuration for uplink reference signals, this disclosure describes details for the association of polarization types with the transmission of uplink reference signals, such as SRS and associated configuration aspects. The described aspects also include utilizing indications of UE polarization capability support with related polarization parameters. The described techniques facilitate the configuration and/or indication of different polarization types with uplink reference signals, such as SRS, where the configuration can be based on UE capability to support one or more polarization types. Additionally, polarization related parameters can be indicated to a network entity in order to correctly configure resources in the polarization domain. Further, techniques for the utilization of polarization to enhance the coverage for uplink reference signals are described.

In further aspects of polarization-based uplink reference signals, the described techniques include a UE providing an indication to a network entity of UE polarization capability, which includes polarization types and related parameters. The disclosure also includes SRS mapping and configuration aspects with polarization, as well as enhancing the coverage of uplink reference signals with polarization, as related to polarization multiplexing of SRS and/or polarization multiplexing of SRS with other uplink signals. Other configuration aspects are described for use of polarization in uplink link adaptation, as well as configuration and reporting aspects for SRS with polarization in positioning.

By utilizing the described techniques, a UE can indicate its capability to support reception and transmission of signals with one or multiple polarization types, where this indication may be either an explicit request from the network or indicated by default. The UE can not only indicate its capability to support one or multiple polarization types, but can also indicate other polarization related parameters so that the network may configure uplink and downlink resources accordingly. Additionally, SRS resources are mapped in the polarization domain, in addition to frequency and time domain. The network (e.g., a location-management function implemented by a network entity) can configure resources for uplink reference signals, such as SRS, in the polarization domain and this configuration relates a polarization type to a SRS-ID, to a SRS resource set ID, or at cell level.

Further, the uplink reference signals, such as SRS, are repeated in the polarization domain to enhance the coverage, where repetitions may use polarization diversity or polarization multiplexing schemes. In one or more implementations, the repetition of SRS may be enhanced in the polarization domain, where in addition to frequency domain repetitions, the SRS is repeated in the polarization domain (e.g., transmitting the SRS symbol using two circular polarization types (LHCP and RHCP)). The multiplexing of SRS with other uplink channels (e.g., PUSCH, PUCCH) or other SRS resources may be carried out in the polarization domain, where the other uplink channels may use one type of polarization, while SRS would use another, different type of polarization. A polarization type can be used, selected, or indicated for uplink link adaptation for codebook and non-codebook based uplink transmission, where in addition to SRI, RI, and TPMI, a polarization type (e.g., Pol-UL) is also indicated by the network for PUSCH data transmission.

Aspects of the present disclosure are described in the context of a wireless communications system. Aspects of the present disclosure are further illustrated and described with reference to device diagrams and flowcharts.

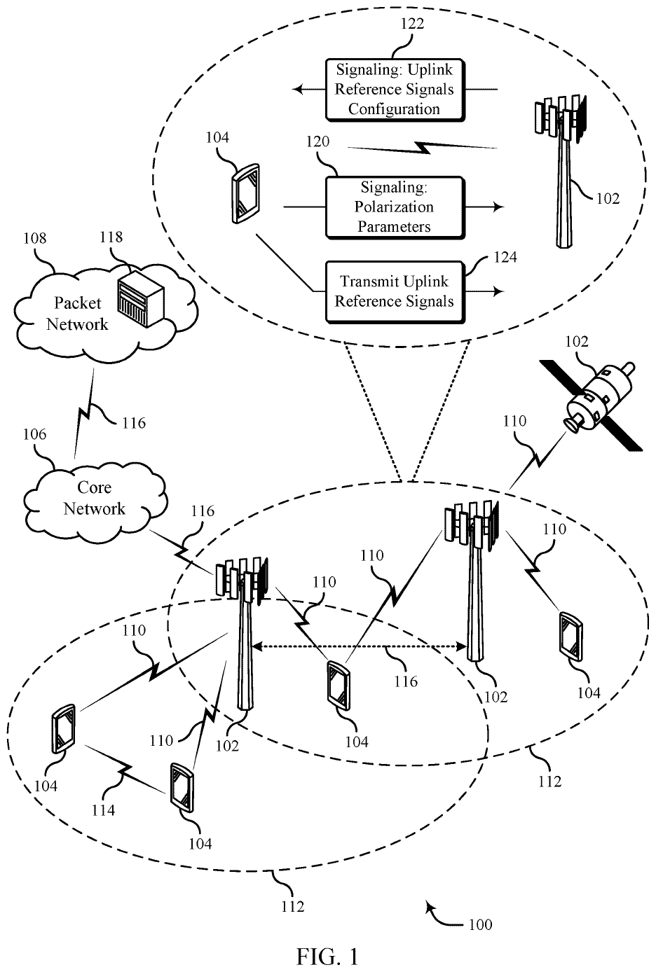

FIG. 1 illustrates an example of a wireless communications system 100 that supports polarization configuration for uplink reference signals in accordance with aspects of the present disclosure. The wireless communications system 100 may include one or more network entities (NE) 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of polarization configuration for uplink reference signals, as described herein. For instance, a UE 104 transmits signaling including one or more polarization parameters 120 for signal reception and signal transmission, and the network entity 102 (e.g., a base station) receives the polarization parameters from the UE. The UE 104 receives, from the network entity 102, a signaling as a configuration 122 for uplink reference signals, where the configuration includes an association of time and frequency resources with at least one polarization type based on the one or more polarization parameters. The UE 104 then transmits uplink reference signals 124 according to the configuration 122 transmitted by the network entity 102 and received by the UE.

With reference to UE sounding procedure, a UE may be configured with one or more SRS resource sets as configured by the higher layer parameter SRS-ResourceSet or SRS-PosResourceSet. For each SRS resource set configured by SRS-ResourceSet, a UE may be configured with K≥1 SRS resources (higher layer parameter SRS-Resource), where the maximum value of K is indicated by UE capability. When a SRS resource set is configured with the higher layer parameter SRS-PosResourceSet, a UE may be configured with K≥1 SRS resources (higher layer parameter SRS-PosResource), where the maximum value of K is 16. The SRS resource set applicability is configured by the higher layer parameter usage in SRS-ResourceSet. When the higher layer parameter usage is set to ‘beamManagement’, only one SRS resource in each of multiple SRS resource sets may be transmitted at a given time instant, but the SRS resources in different SRS resource sets with the same time domain behavior in the same bandwidth part (BWP) may be transmitted simultaneously.

For the SRS resource set(s) configured in srs-ResourceSetToAddModListDCI-0-2 with higher layer parameter usage set to ‘antennaSwitching’ or ‘beamManagement’, the UE expects the same SRS resource set(s) with the same usage being configured in srs-ResourceSetToAddModList. When the UE is configured dl-OrJoint-TCIStateList or transmission configuration indication (TCI)-UL-State, the UE can assume that SRS resource(s) in any SRS resource set, except SRS resource set for positioning and an SRS resource set configured with follow UnifiedTCIstateSRS, can be configured with TCI-State or TCI-UL-State or otherwise updated. The reference RS in the TCI-State can be a channel state information reference signal (CSI-RS) resource in a non-zero power (NZP)-CSI-RS-ResourceSet configured with higher layer parameter repetition, or a CSI-RS resource in an NZP-CSI-RS-ResourceSet configured with higher layer parameter trs-Info. The reference RS in the TCI-UL-State(s) can be a CSI-RS resource in a NZP-CSI-RS-ResourceSet configured with the higher layer parameter repetition, a CSI-RS resource in an NZP-CSI-RS-ResourceSet configured with higher layer parameter trs-Info, an SRS resource with the higher layer parameter usage set to ‘beamManagement’, or synchronization signal block (SSB) or physical broadcast channel (PBCH) block associated with the same or different physical cell identity (PCI) from the PCI of the serving cell.

If an SRS resource set, except an SRS resource set for positioning, is configured with follow UnifiedTCIstateSRS, the UE shall transmit the target SRS resource(s) within the SRS resource set according to the spatial relation, if applicable, with a reference to the reference signal (RS) used for determining uplink (UL) transmit (TX) spatial filter. The RS is determined based on an RS configured with qcl-Type set to ‘typeD’ in QCL-Info of the indicated TCI-State or an RS in the indicated TCI-UL-State. The reference RS in the indicated TCI-State can be a CSI-RS resource in a NZP-CSI-RS-ResourceSet configured with higher layer parameter repetition, or a CSI-RS resource in an NZP-CSI-RS-ResourceSet configured with higher layer parameter trs-Info. The reference RS in the indicated TCI-UL-State can be a CSI-RS resource in a NZP-CSI-RS-ResourceSet configured with higher layer parameter repetition, a CSI-RS resource in an NZP-CSI-RS-ResourceSet configured with higher layer parameter trs-Info, an SRS resource with the higher layer parameter usage set to ‘beamManagement’, or SS/PBCH block associated with the same or different PCI from the PCI of the serving cell.

For aperiodic SRS at least one state of the downlink control information (DCI) field is used to select at least one out of the configured SRS resource set(s). The following SRS parameters are semi-statically configurable by higher layer parameter SRS-Resource or SRS-PosResource. The srs-ResourceId or SRS-PosResourceId determines SRS resource configuration identity. A number of SRS ports, as defined by the higher layer parameter nrofSRS-Ports. If not configured, nrofSRS-Ports is 1. The time domain behavior of SRS resource configuration as indicated by the higher layer parameter resourceType, which may be a periodic, semi-persistent, or aperiodic SRS transmission.

Further, the slot level periodicity and slot level offset as defined by the higher layer parameters periodicityAndOffset-p or periodicityAndOffset-sp for an SRS resource of type periodic or semi-persistent. The UE is not expected to be configured with SRS resources in the same SRS resource set SRS-ResourceSet or SRS-PosResourceSet with different slot level periodicities. For an SRS-ResourceSet configured with higher layer parameter resourceType set to ‘aperiodic’, a slot level offset is defined by the higher layer parameter slotOffset. For an SRS-ResourceSet configured with higher layer parameter resourceType set to ‘aperiodic’, a list of up to four different available slot offset values from the reference slot n+k to the slot where the aperiodic SRS resource set is transmitted, where n is the slot with triggering DCI and k is slotOffset, can be configured by the higher layer parameter availableSlotOffsetList. The parameter availableSlotOffsetList can be configured with up to 4 different values. For an SRS-PosResourceSet configured with higher layer parameter resourceType set to ‘aperiodic’, the slot level offset is defined by the higher layer parameter slotOffset for each SRS resource.

Further, a number of OFDM symbols in the SRS resource, starting OFDM symbol of the SRS resource within a slot including repetition factor R as defined by the higher layer parameter resourceMapping. If R is not configured, then R is equal to the number of OFDM symbols in the SRS resource. The SRS bandwidth BsRs and CsRs, as defined by the higher layer parameter freqHopping. If not configured, then BARS=0. Frequency hopping bandwidth bₕₒₚ, as defined by the higher layer parameter freqHopping. If not configured, then bₕₒₚ=0. Defining partial frequency sounding factor and start resource block (RB) index for partial frequency sounding as defined by the higher layer parameters FreqScalingFactor P_{F} and StartRBIndex k_{F}, respectively. If not configured, then P_{F}=1 and k_{F},=0. Defining start RB index hopping for partial frequency sounding in different SRS frequency hopping periods for aperiodic, periodic, and/or semi-persistent SRS based on the hopping pattern kₕₒₚ. If not configured, then start RB hopping is not enabled and kₕₒₚ is fixed to be 0 for all SRS symbols. Defining frequency domain position and configurable shift, as defined by the higher layer parameters freqDomainPosition and freqDomainShift, respectively. If freqDomainPosition is not configured, freqDomainPosition is zero.

Further, the cyclic shift, as defined by the higher layer parameter cyclicShift-n2, cyclicShift-n4, or cyclicShift-n8 for transmission comb value 2, 4 or 8. The transmission comb value, as defined by the higher layer parameter transmissionComb. The transmission comb offset, as defined by the higher layer parameter combOffset-n2, combOffset-n4, and combOffset-n8 for transmission comb value 2, 4, or 8. The SRS sequence ID, as defined by the higher layer parameter sequenceId. The configuration of the spatial relation between a reference RS and the target SRS, where the higher layer parameter spatialRelationInfo or spatialRelationInfoPos, if configured, contains the ID of the reference RS. The reference RS may be an SS/PBCH block, CSI-RS configured on serving cell indicated by higher layer parameter servingCellId if present, same serving cell as the target SRS otherwise, or an SRS configured on uplink BWP indicated by the higher layer parameter uplinkBWP, and serving cell indicated by the higher layer parameter servingCellId if present, otherwise the same serving cell as the target SRS. When the target SRS is configured by the higher layer parameter SRS-PosResourceSet, the reference RS may also be a downlink (DL) positioning reference signal (PRS) configured on a serving cell or a non-serving cell indicated by the higher layer parameter dl-PRS, or an SS/PBCH block of a non-serving cell indicated by the higher layer parameter ssb-Ncell. If the UE is configured with dl-OrJoint-TCIStateList or TCI-UL-State, the reference RS may additionally be an SS/PBCH block associated with a PCI different from the PCI of the serving cell.

Additionally, the UE may be configured by the higher layer parameter resourceMapping in SRS-Resource with an SRS resource occupying N_{S}∈{1, 2, 4} adjacent OFDM symbols within the last 6 symbols of the slot, or at any symbol location within the slot if resourceMapping-r16 is provided subject to UE capability, where all antenna ports of the SRS resources are mapped to each symbol of the resource. When the SRS is configured with the higher layer parameter SRS-PosResourceSet, the higher layer parameter resourceMapping-r16 in SRS-PosResource indicates an SRS resource occupying N_{S}{1, 2, 4, 8, 12} adjacent symbols anywhere within the slot. When the SRS is configured with the higher layer parameter SRS-ResourceSet, the higher layer parameter resourceMapping-r17 in SRS-Resource indicates an SRS resource occupying N_{S}∈{1, 2, 4, 8, 10, 12, 14} adjacent symbols anywhere within the slot.

If a PUSCH with a priority index 0 and SRS configured by SRS-Resource are transmitted in the same slot on a serving cell, the UE may only be configured to transmit SRS after the transmission of the PUSCH and the corresponding demodulation reference signal (DMRS). If a PUSCH transmission with a priority index 1 or a PUCCH transmission with a priority index 1 would overlap in time with an SRS transmission on a serving cell, the UE does not transmit the SRS in the overlapping symbol(s).

TABLE 1
User Equipment (UE) radio access capabilities.
Definitions for feature

eCall over IMS (IP Multimedia Subsystem)
It is optional for aUE to support eCall over IMS as specified in TS 38.331 [9].
Access Category 1 selection assistance information enhancement
It is optional for a UE that is configured for delay tolerant service to support Access Category 1
selection assistance information enhancement, according to uac-AC1-SelectAssistInfo-r16 as
specified in TS 38.331 [9].
Random access prioritization for MPS and MCS
It is optional for a UE that is configured for MPS or MCS to support random access prioritization
for Access Identity 1 or 2 as specified in TS 38.321 [8].
HSDN cell reselection
It is optional for a UE to support HSDN cell reselection priority handling in
RRC_IDLE/RRC_INACTIVE as specified in TS 38.304 [21] and TS 38.331 [9].
TRS occasions for idle mode and RRC_INACTIVE UEs
It is optional for a UE to support reading tracking reference signal (TRS) configuration from SIB
and receiving L1 indication for TRS availability.
NOTE: Receiving L1 indication via DCI format 2_7 is supported only if the UE supports
receiving DCI format 2_7.
Minimization of service interruption
It is optional for a UE to support minimization of service interruption including reporting to NAS
of disaster roaming information for available PLMNs and Access Barring check for Access
Identity 3, as specified in TS 38.331 [9].
Random access prioritization for Slicing
It is optional for a UE to support slice-based prioritization for random access as specified in TS
38.321 [8].
Random access partitioning for Slicing
It is optional for a UE to support slice-based RACH partitioning as specified in TS 38.321 [8].
Relaxed cell reselection on GEO
It is optional for a UE to support the relaxed cell reselection on GEO.
Support of polarization signaling in NR NTN
It is optional for a UE to support the polarization signaling in NR NTN with the following
functional components:
Support polarization indication reception in SIB indicating DL and/or UL polarization
information using respective polarization type parameters to indicate: RHCP or LHCP or
linear;
Support polarization signaling for target serving cell in handover command message;
Support polarization signaling for non-serving cell in radio resource management (RRM)
measurement configuration.

In aspects of polarization configuration for uplink reference signals, as described herein, polarization types can be associated with the transmission of uplink reference signals, such as SRS and associated configuration aspects. The described aspects also include utilizing indications of UE polarization capability support with related polarization parameters. The described techniques facilitate the configuration and/or indication of different polarization types with uplink reference signals, such as SRS, where the configuration can be based on UE capability to support one or more polarization types. Additionally, polarization related parameters can be indicated to a network entity in order to correctly configure resources in the polarization domain. Further, techniques for the utilization of polarization to enhance the coverage for uplink reference signals are described.

By utilizing the described techniques, a UE can indicate its capability to support reception and transmission of signals with one or multiple polarization types, where this indication may be either an explicit request from the network or indicated by default. The UE can not only indicate its capability to support one or multiple polarization types, but can also indicate other polarization related parameters so that the network may configure uplink and downlink resources accordingly. Additionally, SRS resources are mapped in the polarization domain, in addition to frequency and time domain. The network (e.g., a location-management function implemented by a network entity) can configure resources for uplink reference signals, such as SRS, in the polarization domain and this configuration relates a polarization type to a SRS-ID, to a SRS resource set ID, or at cell level.

Further, the uplink reference signals, such as SRS, are repeated in the polarization domain to enhance the coverage, where repetitions may use polarization diversity or polarization multiplexing schemes. In one or more implementations, the repetition of SRS may be enhanced in the polarization domain, where in addition to frequency domain repetitions, the SRS is repeated in the polarization domain (e.g., transmitting the SRS symbol using two circular polarization types (LHCP and RHCP)). The multiplexing of SRS with other uplink channels (e.g., PUSCH, PUCCH) or other SRS resources may be carried out in the polarization domain, where the other uplink channels may use one type of polarization, while SRS would use another, different type of polarization. A polarization type can be used, selected, or indicated for uplink link adaptation for codebook and non-codebook based uplink transmission, where in addition to SRI, RI, and TPMI, a polarization type (e.g., Pol-UL) is also indicated by the network for PUSCH data transmission.

With reference to UE polarization capability indication to the network, the UE indicates its capability to support reception and transmission of signals with one or more polarization types, where this indication may be based on either an explicit request from the network or indicated by default from the UE. In an implementation, the UE not only indicates its capability to support one or more polarization types, but can also indicate other polarization related parameters so that the network may configure uplink and downlink resources accordingly. The polarization based parameters can include a polarization type support, polarization related to a number of antennas, a polarization switching capability, and/or a polarization switching delay.

The polarization type support can indicate all of the types of polarizations that are supported by the UE, for example in a field NTN-ULPolsupport={linear, LHCP, RHCP}. However, only this information for the type of polarizations may not be sufficient for better resource scheduling as it does not indicate to the network that all of the device antennas have the indicated polarization support, or the polarization support varies over different antennas. Therefore, the polarization relationship with the antennas may also be indicated, such as the number of polarization types that may be simultaneously used for data transmission and reception. Further, some UEs may have polarization switching capability (i.e., switching from one polarization type to another polarization type), and can therefore indicate the polarization switching capability and a polarization switching delay (i.e., a minimum switching delay that is required for polarization switching, such as from linear to LHCP, from LHCP to RHCP, or vice versa).

In an example, the polarization switching capability may also consider the polarization relation with the number of antennas (i.e., some antennas may transmit and/or receive multiple polarization types simultaneously, while some of the antennas may perform in a time division multiplexing (TDM) manner. For example, a UE may have four antennas, yet only two out of the four antennas may transmit and/or receive with multiple polarization types simultaneously. The other two antennas may transmit and/or receive multiple polarization types, but in a TDM manner, such as having the capability of switching between different polarization types, but with the need for a minimum delay. In one or more implementations, some of the antenna may only support one polarization type, and this may also be indicated by the UE in the UE capability indication. For example, a UE with four antennas may have the polarization support of LHCP and RHCP for two of the antennas (with or without simultaneous polarization switching support), while the other two antennas may have only linear polarization support. This information can be used by the network to configure resources for downlink reception and uplink transmission. For instance, this may be significant on uplink channel sounding because of polarization mismatch errors. In addition, such information may be of significance for implementations of polarization based uplink and/or downlink (UL/DL) diversity and multiplexing schemes.

In one or more implementations, the UE can explicitly indicate its capability to support a polarization type in the UE capability exchange, where this indication may be valid for any signal used for data reception and transmission. In an implementation, this information may be specific to a type of reference signal (e.g., SRS). In this case, the UE may indicate the polarization types and corresponding parameters that may be used for SRS. In an implementation, this information can be indicated in UE SRS capability signaling, where the polarization support is indicated in supportedSRS-Resources, while polarization switching capability may be indicated in SRS-TXSwitch.

With reference to SRS mapping and configuration with polarization, SRS resources are mapped in the polarization domain in addition to the frequency and time domain. The network can configure resources for uplink reference signals, such as SRS, in the polarization domain, and this configuration may relate a polarization type to an SRS-ID, to a SRS resource set ID, or at a cell level. In one or more implementations for SRS mapping with polarization type, the SRS is mapped in the polarization domain in addition to the time domain, thus utilizing polarization as an additional dimension for orthogonal SRS signal mapping. The SRS types may include SRS for positioning or multiple input multiple output (MIMO) SRS. In this case, the UE can be configured to utilize the same frequency and time resources, but differ in the polarization domain. For example, a field may be used to indicate to the UE whether SRS resource mapping is supported and/or configured, or not (e.g., a field in SRS-Resource configuration may be used (SRS-Polresourcemapping=Enumerated {supported, not supported}).

In one or more implementations, the polarization domain is embedded in the resource mapping of SRS symbols in a slot, where an order of the mapping of the resources in the frequency, time, and polarization domain can be either specified (e.g., in specifications) and may be the same for all UEs, or the order may be specific to a UE and is configured along with the SRS resources (e.g., in a SRS resource configuration). In an implementation, the mapping may be in the increasing order of frequency, polarization, and time (i.e., first resources are configured in the frequency domain, then different polarizations are configured for the same frequency resources and then increased in the time domain). The mapping in the polarization domain may depend on UE capability to support one or multiple polarizations in a simultaneous manner or in a TDM manner.

In one or more implementations, the number of ports for SRS may be increased to reflect the polarization mapping. For example, instead of using four ports in NR specifications for SRS (where four time domain symbols are supported with four mandatory Rx antennas), the ports may be doubled for use of circular polarization types (i.e., eight ports (four ports with LHCP and four ports with RHCP)). In implementations, the same or different polarizations may be used for repeated SRSs (e.g., for both frequency and time domain repetitions). For example, if an SRS is configured to be repeated twice in a frequency/time domain, the UE may additionally be configured to use the same or different polarization types with these frequency/time domain repetitions (e.g., LHCP for both frequency/time domain repetitions, or LHCP with first frequency/time domain resources and RHCP with other frequency/time domain resources).

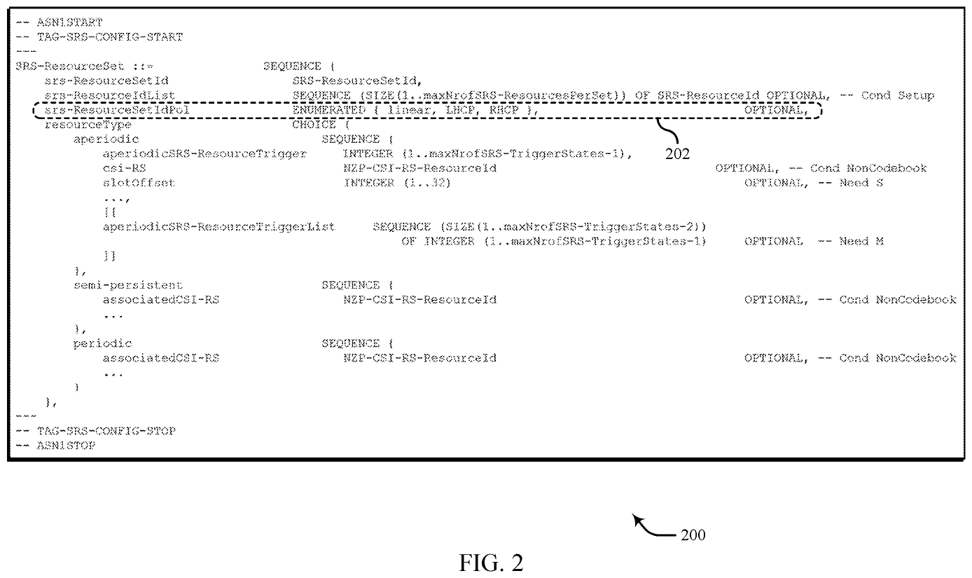

FIG. 2 illustrates an example 200 of a SRS-Config information element, which supports polarization configuration for uplink reference signals in accordance with aspects of the present disclosure. In one or more implementations for configuration of polarization with SRS, the configuration of a polarization is related to a resource set, where for each of the resource set configurations, a polarization type is configured. This can establish that the indicated polarization type is to be used for all SRS resources belonging to a particular resource set, where the type of polarization may be indicated under the SRS-ResourseSet IE, as illustrated in this example 200.

In an implementation, one polarization type is associated with all of the SRS resource sets, and a field 202 may be used to indicate that the polarization is valid for all SRS resource sets. In another implementation, the association of a polarization type with SRS is indicated on a SRS resource level, where a polarization type is configured for each SRS resource ID. This configuration establishes that signals from all of the SRS ports are transmitted using the same polarization. In another implementation, the association of a polarization type with SRS is based on SRS symbols, where a polarization type is configured for each of the SRS symbols. In this case, the indication may be related to SRS resource mapping, where a polarization type is configured for each of the SRS symbols by using a field (e.g., under a ‘resourceMapping’).

In another embodiment, there is no explicit indication of polarization type to be used for SRS, rather it is determined by the spatial relation information. For instance, a quasi co-location (QCL) indication can be used to indicate the association between a downlink reference source signal and SRS in terms of polarization type, where either the existing QCL types in NR are updated to include polarization or a new QCL type is defined that indicates a polarization relationship between reference RS and SRS. For example, the field spatialRelationInfo may contain the ID of a reference signal, such as SSB, CSI-RS to indicate the spatial relation between an indicated reference signal and a target SRS. In this case, the target SRS would use the same polarization type as used in the reference signal. Similarly, for SRS in positioning, the field spatialRelationInfo in SRS-PosResourceSet may refer to DL-PRS as reference signal, thus the target SRS may use the same polarization as used for DL-PRS.

In an implementation, the target UE and NG-RAN use one of the polarization types based on their capability and indicate in its measurement report about the type of polarization type utilized by the target UE and NG-RAN. In an implementation, the polarization type for SRS is configured to the target UE, however, it may be up to UE to use the configured polarization type based on its capability. In this case, the UE may indicate in its measurement report or by dedicated signaling (e.g., UCI, UL MAC CE) about the polarization type it may have used for SRS transmission. For example, if SRS is to be used for positioning, the target UE may include in its measurement report the positioning method about the polarization type that is used for SRS transmission.

In an implementation, the polarization type to be used for SRS is configured at cell level, where one or multiple polarization types to be used at a cell are indicated by common or dedicated signaling (e.g., as part of NTN SIB by a field SRS-polarization type). In an implementation, the polarization type for SRS in a cell may be indicated as part of cell handover configurations, where a polarization type for SRS for serving and neighboring cells can be configured in a cell handover procedure.

In an implementation, the UE is configured with one polarization type for either periodic, semi-periodic, or aperiodic SRS transmission, and the UE would use the same polarization type with all SRS resources within either of the configured periodic, semi-periodic, or aperiodic SRS transmissions. In an implementation, the UE is configured with different polarization types for either periodic, semi-periodic, or aperiodic SRS transmission, where a relationship of the polarization types may be separately defined or configured. For example, a periodic change interval may be configured (e.g., in terms of slots), meaning that a polarization type would change after how many slots and so on. This establishes that SRS transmission within those slots would use one type of polarization, and then afterwards the new polarization type.

With reference to polarization multiplexing of SRS for coverage enhancement, the uplink reference signals such as SRS are repeated in the polarization domain to enhance the coverage, where repetitions may use polarization diversity or polarization multiplexing schemes. In an implementation, the repetition of SRS can be enhanced in the polarization domain, where in addition to frequency domain repetitions, the SRS is repeated in the polarization domain (e.g., transmitting SRS symbols using two circular polarization types (LHCP and RHCP). In this case, the UE uses the same frequency and time resources, but differs in the polarization domain. Such polarization-based repetitions can be used for configuring SRS transmissions for both PUSCH and positioning purposes.

In one or more implementations, the UE receives a configuration of the resources (in time, frequency, and polarization domain) and corresponding indications for activation and deactivation of the polarization-based repetition method from the network. In an implementation, the configuration of the resources can be carried out using higher layer signaling (i.e., RRC signaling), whereas activation and deactivation of polarization-based repetitions may be indicated in either a RRC configuration or dynamically through DCI or MAC CE.

In an implementation, the UE may determine itself when to employ a polarization repetition, either autonomously or based on a predefined criteria from the network. For example, a UE can determine to employ polarization-based repetition based on its capability to support a polarization-based repetition. In an implementation, a reference signal received power (RSRP) threshold value for a downlink signal (e.g., CSI-RS, SSB) is set by the network, and the UE is expected to employ a polarization-based repetition for SRS as soon as the UE detects that a RSRP threshold value falls below the predefined value.

In an implementation, the UE transmits the same SRSs using the same frequency and time resources, but differs in polarization domain (polarization diversity), where the UE either receives an implicit or explicit indication to employ this repetition (e.g., explicitly by RRC, DCI, or MAC CE signaling, or implicitly, such as by defining a threshold), or the UE determines autonomously. In an implementation, the number of repetitions for SRS is confined to two circular polarization types (i.e., LHCP and RHCP) and is used as the default method for repetitions. For example, a parameter field “PolRep” with values {0, 1} may be used in SRS config to indicate this default repetition method (i.e., if this field is false, then there would be no repetition and if this field is true, the UE shall employ repetition in the polarization domain by transmitting the same configured SRS resources in both LHCP and RHCP).

In an implementation, the UE transmits the different SRSs using the same frequency and time resources, but differs in polarization domain (polarization multiplexing), where the UE either receives an implicit or explicit indication to employ this repetition (e.g., explicitly by RRC, DCI, or MAC CE signaling, or implicitly, such as by defining a threshold), or the UE determines autonomously. In this case, the UE generates different SRS signals for each type of polarization that would be used for transmitting the SRS signal on same the frequency and/or time resources.

In an implementation, the polarization-based repetitions may be combined with frequency and/or time domain repetitions of the SRSs, where additionally, the same or different types of polarization-based repetitions can be used for frequency and/or time domain repetitions of SRS. For example, if an SRS is configured to be repeated twice in a frequency and/or time domain, the UE can additionally be configured for repetitions in the polarization domain (e.g., using polarization diversity along with these frequency and/or time domain repetitions. In this case, and in addition to the time and/or frequency domain repetitions, the UE would transmit on the same time and/or frequency resources with both LHCP and RHCP polarizations.

With reference to multiplexing of SRS with other uplink signals in the polarization domain, the multiplexing of SRS with other uplink channels (e.g., PUSCH, PUCCH) or other SRS resources may be carried out in the polarization domain, where other uplink channels (e.g., PUSCH, PUCCH) may use one type of polarization while SRS would use one type of polarization. For example, current NR specifications allow only TDM multiplexing of SRS and PUSCH, where SRS may only be transmitted after PUSCH and its corresponding DMRS. However, if polarization-based multiplexing is used, then SRS may be transmitted with one type of polarization (e.g., LHCP) and PUSCH may be transmitted with another type of polarization (e.g., RHCP) at the same time instant. Similarly, PUCCH and SRS may be multiplexed in the polarization domain (i.e., transmitting PUCCH with one polarization type while SRS with another polarization type).

With reference to polarization type in uplink link adaption and channel sounding, a polarization type is used, selected, or indicated for uplink link adaptation for codebook and non-codebook based uplink transmission, where in addition to a SRI, RI, and TPMI, a polarization type (e.g., Pol-UL) is also indicated by the network for PUSCH data transmission. This can be indicated by a field in DCI used for PUSCH data scheduling (e.g., in DCI format 0_0 or 0_1 or through MAC CE). For example, in the case of codebook based transmissions, a UE transmits a set of non-precoded SRS with one or multiple polarization types that may either be configured by the network or selected by the UE. If selected by the UE autonomously, the UE can indicate the one or multiple polarization types to the network (e.g., in UCI). The network employs this SRS to select the appropriate antenna port for PUSCH, selects the appropriate rank, polarization type, and precoding weights, and indicates these accordingly in the DCI or MAC CE. In an implementation, a reciprocity for a polarization type may be assumed for uplink and downlink channel, and indicated by the network.

In an implementation, the polarization types are used along with antenna switching for UE sounding procedures (e.g., for supporting reciprocity based operation (for DL CSI acquisition) or for determining which polarizations are best suited for uplink and/or downlink channels). This may either be done by creating a field in SRS configuration (e.g., defining a new “usage” field or be part of usage=antennaSwitching). The configuration of SRS resources would depend on the UE capability which is expressed in terms of the number of simultaneously usable Tx and Rx chains (including polarization chains). Moreover, it would also depend on the UE capabilities to support one or multiple polarization types along with their relation to antennas and polarization switching capability. In an implementation, when a polarization switching delay is indicated in the UE capability, the resources are configured in such a way that there is a minimum gap corresponding to that switching delay.

With reference to configuration and reporting aspects for SRS with polarization in positioning, one or multiple polarization types (e.g., RHCP and LHCP) are associated with different SRS signals to be used for uplink transmission and reception for positioning purposes, where this association may either be configured by a location server to the NG-RAN node and target UE, or by the NG-RAN node to the target UE. In an implementation, the NG-RAN node (or gNB) determines the polarization type to be used for SRS transmission and configures the association of the polarization type with SRS resources using RRC signaling. The NG-RAN node may indicate to the location server the type of polarization that is configured for uplink SRS.

In an implementation, the location server configures the polarization types to be used for SRS transmission and reception (i.e., to both a target UE and the NG-RAN node) which may be based on indicated NG-RAN node polarization support (e.g., by information exchanged messaging using NRPPa) and indicated UE capabilities (e.g., UE capability information exchanged using LTE positioning protocol (LPP)). In an implementation, the location server indicates to NG-RAN node to configure the target UE with a polarization type for SRS transmission.

In an implementation, the UE is configured by the NG-RAN node or location server to report a polarization type that is used for UL-SRS transmission for a positioning method (e.g., multi-round trip time (RTT)). The UE would indicate this by a field in the location estimate measurement report of that method, showing which polarization type is used for UL-SRS. In an implementation, the target UE would indicate the UL-SRS polarization type in the measurement report with or without any indication by the location server or the NG-RAN node.

In an implementation, the NG-RAN node can indicate to the location server the polarization type that is used for UL-SRS reception for a positioning method, and may include it as part of measurement report messages. This indication can either be on an indication in the request message, or the NG-RAN node can include it as part of a report message for a positioning method that utilizes SRS. For example, for the multi-RTT measurement report procedure between a NG-RAN node and a location server, the NG-RAN node can include a field to indicate the polarization used for UL-SRS reception along with gNB Rx-Tx difference.

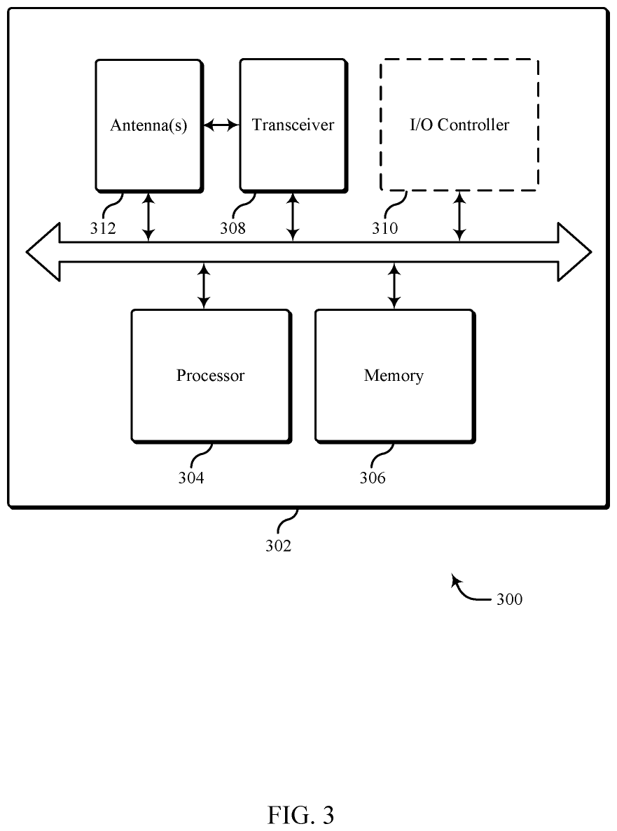

FIG. 3 illustrates an example of a block diagram 300 of a device 302 that supports polarization configuration for uplink reference signals in accordance with aspects of the present disclosure. The device 302 may be an example of a UE 104 as described herein. The device 302 may support wireless communication with one or more network entities 102, UEs 104, or any combination thereof. The device 302 may include components for bi-directional communications including components for transmitting and receiving communications, such as a processor 304, a memory 306, a transceiver 308, and an I/O controller 310. These components may be in electronic communication or otherwise coupled (e.g., operatively, communicatively, functionally, electronically, electrically) via one or more interfaces (e.g., buses).

The processor 304, the memory 306, the transceiver 308, or various combinations thereof or various components thereof may be examples of means for performing various aspects of the present disclosure as described herein. For example, the processor 304, the memory 306, the transceiver 308, or various combinations or components thereof may support a method for performing one or more of the operations described herein.

In some implementations, the processor 304, the memory 306, the transceiver 308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 304 and the memory 306 coupled with the processor 304 may be configured to perform one or more of the functions described herein (e.g., executing, by the processor 304, instructions stored in the memory 306).

For example, the processor 304 may support wireless communication at the device 302 in accordance with examples as disclosed herein. The processor 304 may be configured as or otherwise support a means for transmitting a first signaling including one or more polarization parameters for signal reception and signal transmission; receiving a second signaling as a configuration for uplink reference signals, the configuration including an association of time and frequency resources with at least one polarization type based at least in part on the one or more polarization parameters; and transmitting the uplink reference signals according to the configuration.

Additionally, the processor 304 may be configured as or otherwise support any one or combination of the method further comprising receiving a third signaling as a reporting configuration of a request to indicate a polarization capability. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with a network entity. The configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The method further comprising transmitting a third signaling as an indication of a polarization type used for uplink resources in UCI or in uplink MAC CE. The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

Additionally, or alternatively, the device 302, in accordance with examples as disclosed herein, may include a processor and a memory coupled with the processor, the processor configured to cause the apparatus to: transmit a first signaling including one or more polarization parameters for signal reception and signal transmission; receive a second signaling as a configuration for uplink reference signals, the configuration including an association of time and frequency resources with at least one polarization type based at least in part on the one or more polarization parameters; and transmit the uplink reference signals according to the configuration.

Additionally, the wireless communication at the device 302 may include any one or combination of the processor is configured to cause the apparatus to receive a third signaling as a reporting configuration of a request to indicate a polarization capability of the apparatus. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported by the apparatus. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with a network entity. The configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The processor is configured to cause the apparatus to transmit a third signaling as an indication of a polarization type used for uplink resources in UCI or in uplink MAC CE. The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

The processor 304 of the device 302, such as a UE 104, may support wireless communication in accordance with examples as disclosed herein. The processor 304 includes at least one controller coupled with at least one memory, and is configured to or operable to cause the processor to transmit a first signaling including one or more polarization parameters for signal reception and signal transmission; receive a second signaling as a configuration for uplink reference signals, the configuration including an association of time and frequency resources with at least one polarization type based at least in part on the one or more polarization parameters; and transmit the uplink reference signals according to the configuration.

The processor 304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 304 may be configured to operate a memory array using a memory controller. In some other implementations, a memory controller may be integrated into the processor 304. The processor 304 may be configured to execute computer-readable instructions stored in a memory (e.g., the memory 306) to cause the device 302 to perform various functions of the present disclosure.

The memory 306 may include random access memory (RAM) and read-only memory (ROM). The memory 306 may store computer-readable, computer-executable code including instructions that, when executed by the processor 304 cause the device 302 to perform various functions described herein. The code may be stored in a non-transitory computer-readable medium such as system memory or another type of memory. In some implementations, the code may not be directly executable by the processor 304 but may cause a computer (e.g., when compiled and executed) to perform functions described herein. In some implementations, the memory 306 may include, among other things, a basic I/O system (BIOS) which may control basic hardware or software operation such as the interaction with peripheral components or devices.

The I/O controller 310 may manage input and output signals for the device 302. The I/O controller 310 may also manage peripherals not integrated into the device M02. In some implementations, the I/O controller 310 may represent a physical connection or port to an external peripheral. In some implementations, the I/O controller 310 may utilize an operating system such as iOS®, ANDROID®, MS-DOS®, MS-WINDOWS®, OS/2®, UNIX®, LINUX®, or another known operating system. In some implementations, the I/O controller 310 may be implemented as part of a processor, such as the processor 304. In some implementations, a user may interact with the device 302 via the I/O controller 310 or via hardware components controlled by the I/O controller 310.

In some implementations, the device 302 may include a single antenna 312. However, in some other implementations, the device 302 may have more than one antenna 312 (i.e., multiple antennas), including multiple antenna panels or antenna arrays, which may be capable of concurrently transmitting or receiving multiple wireless transmissions. The transceiver 308 may communicate bi-directionally, via the one or more antennas 312, wired, or wireless links as described herein. For example, the transceiver 308 may represent a wireless transceiver and may communicate bi-directionally with another wireless transceiver. The transceiver 308 may also include a modem to modulate the packets, to provide the modulated packets to one or more antennas 312 for transmission, and to demodulate packets received from the one or more antennas 312.

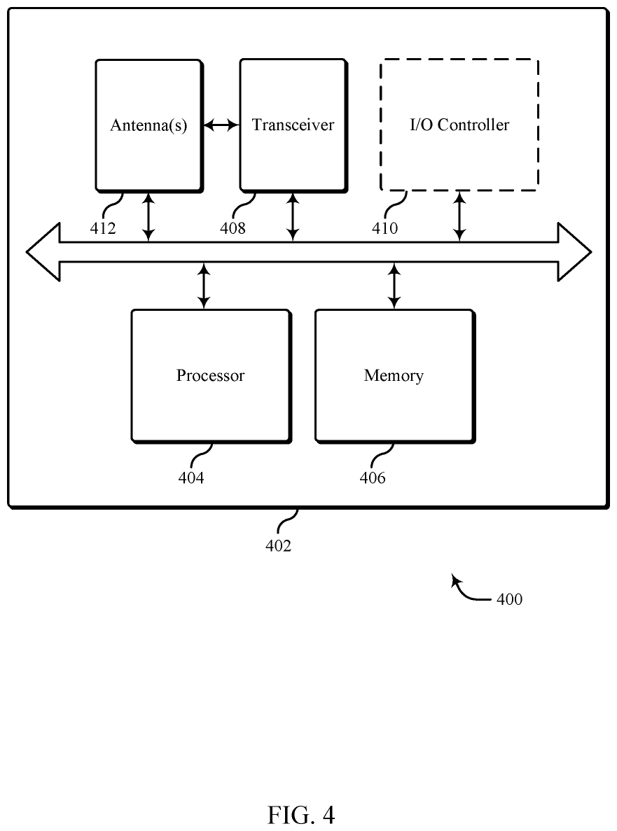

FIG. 4 illustrates an example of a block diagram 400 of a device 402 that supports polarization configuration for uplink reference signals in accordance with aspects of the present disclosure. The device 402 may be an example of a network entity 102 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for receiving, from a UE, a first signaling including one or more polarization parameters for signal reception and signal transmission; and transmitting, to the UE, a second signaling as a configuration for uplink reference signals, the configuration including an association of time and frequency resources with at least one polarization type based at least in part on the one or more polarization parameters.

Additionally, the processor 404 may be configured as or otherwise support any one or combination of the method further comprising transmitting, to the UE, a third signaling as a reporting configuration of a request to indicate a polarization capability of the UE. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported by the UE. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with the UE. The configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The method further comprising receiving, from the UE, a third signaling as an indication of a polarization type used for uplink resources in UCI or in uplink MAC CE. The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

Additionally, or alternatively, the device 402, in accordance with examples as disclosed herein, may include a processor and a memory coupled with the processor, the processor configured to cause the apparatus to: receive, from a UE, a first signaling including one or more polarization parameters for signal reception and signal transmission; and transmit, to the UE, a second signaling as a configuration for uplink reference signals, the configuration including an association of time and frequency resources with at least one polarization type based at least in part on the one or more polarization parameters.

Additionally, the wireless communication at the device 402 may include any one or combination of the processor is configured to cause the apparatus to transmit, to the UE, a third signaling as a reporting configuration of a request to indicate a polarization capability of the UE. The one or more polarization parameters for the signal reception and the signal transmission includes at least one of a polarization type support, polarization related to a number of antennas, a polarization switching capability, or a polarization switching delay. The polarization type support includes an indication of one or more polarization types, including at least one of linear polarization, RHCP, or LHCP that is supported by the apparatus. The configuration includes a mapping of the one or more polarization types to antenna reception and transmission chains. The configuration includes a number of antenna reception and transmission chains that can switch from a first polarization type to a second polarization type. The configuration includes a minimum delay in time units to switch from a first polarization type to a second polarization type. The one or more polarization parameters for the signal reception and the signal transmission are transmitted in an apparatus capability exchange with the UE. The configuration includes a mapping of resources for the uplink reference signals in a time, frequency, and polarization domain. An order of the mapping of the resources is specified in a frequency domain, a time domain, and the polarization domain. The configuration indicates a single polarization type for multiple SRSs included in a resource set. The configuration indicates configured resources for the uplink reference signals using spatial relation information, and the configuration includes an indication of a polarization type of a downlink source reference signal. The processor is configured to cause the apparatus to receive, from the UE, a third signaling as an indication of a polarization type used for uplink resources in UCI or in uplink MAC CE. The configuration indicates a repeating uplink reference signal with multiple polarizations. The configuration includes a first association of the time and frequency resources with a polarization type for a first type of the uplink reference signals, and includes a second association of the time and frequency resources with a different polarization type for a second type of the uplink reference signals. The configuration includes a polarization type associated with a SRS for positioning measurements.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device 402. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

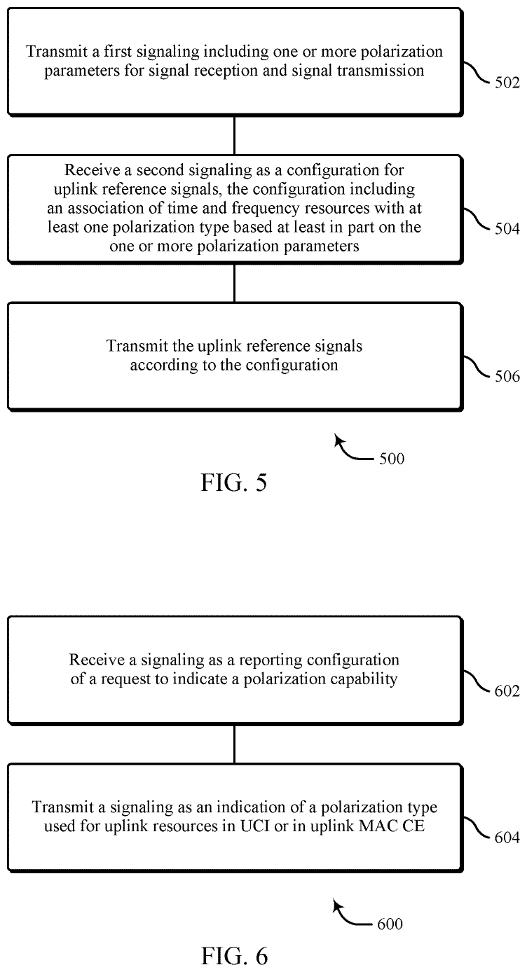

FIG. 5 illustrates a flowchart of a method 500 that supports polarization configuration for uplink reference signals in accordance with aspects of the present disclosure. The operations of the method 500 may be implemented by a device or its components as described herein. For example, the operations of the method 500 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 502, the method may include transmitting a first signaling including one or more polarization parameters for signal reception and signal transmission. The operations of 502 may be performed in accordance with examples as described herein. In some implementations, aspects of the operations of 502 may be performed by a device as described with reference to FIG. 1.

At 504, the method may include receiving a second signaling as a configuration for uplink reference signals, the configuration including an association of time and frequency resources with at least one polarization type based at least in part on the one or more polarization parameters. The operations of 504 may be performed in accordance with examples as described herein. In some implementations, aspects of the operations of 504 may be performed by a device as described with reference to FIG. 1.

At 506, the method may include transmitting the uplink reference signals according to the configuration. The operations of 506 may be performed in accordance with examples as described herein. In some implementations, aspects of the operations of 506 may be performed by a device as described with reference to FIG. 1.

FIG. 6 illustrates a flowchart of a method 600 that supports polarization configuration for uplink reference signals in accordance with aspects of the present disclosure. The operations of the method 600 may be implemented by a device or its components as described herein. For example, the operations of the method 600 may be performed by a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include receiving a third signaling as a reporting configuration of a request to indicate a polarization capability. The operations of 602 may be performed in accordance with examples as described herein. In some implementations, aspects of the operations of 602 may be performed by a device as described with reference to FIG. 1.

At 604, the method may include transmitting a third signaling as an indication of a polarization type used for uplink resources in UCI or in uplink MAC CE. The operations of 604 may be performed in accordance with examples as described herein. In some implementations, aspects of the operations of 604 may be performed by a device as described with reference to FIG. 1.

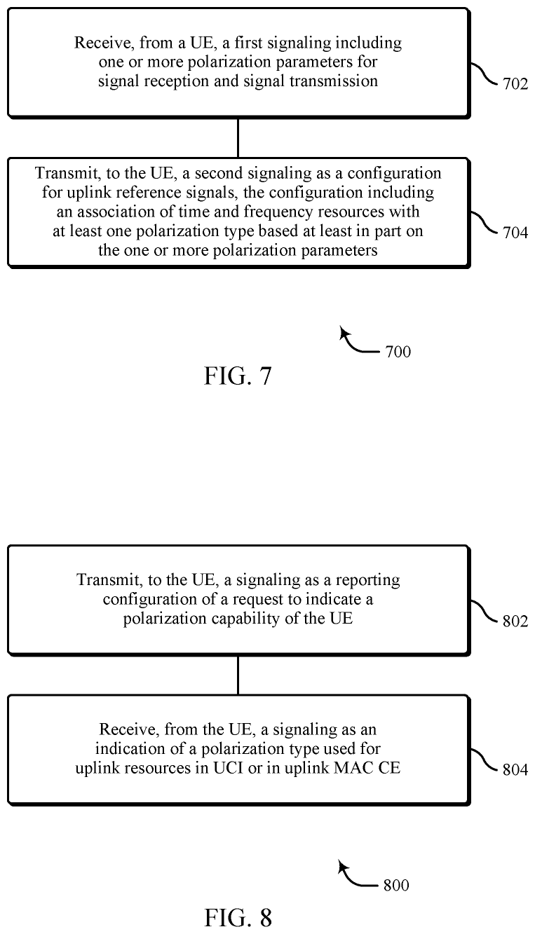

FIG. 7 illustrates a flowchart of a method 700 that supports polarization configuration for uplink reference signals in accordance with aspects of the present disclosure. The operations of the method 700 may be implemented by a device or its components as described herein. For example, the operations of the method 700 may be performed by a network entity 102 (e.g., a base station) as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include receiving, from a UE, a first signaling including one or more polarization parameters for signal reception and signal transmission. The operations of 702 may be performed in accordance with examples as described herein. In some implementations, aspects of the operations of 702 may be performed by a device as described with reference to FIG. 1.

At 704, the method may include transmitting, to the UE, a second signaling as a configuration for uplink reference signals, the configuration including an association of time and frequency resources with at least one polarization type based at least in part on the one or more polarization parameters. The operations of 704 may be performed in accordance with examples as described herein. In some implementations, aspects of the operations of 704 may be performed by a device as described with reference to FIG. 1.

FIG. 8 illustrates a flowchart of a method 800 that supports polarization configuration for uplink reference signals in accordance with aspects of the present disclosure. The operations of the method 800 may be implemented by a device or its components as described herein. For example, the operations of the method 800 may be performed by a network entity 102 (e.g., a base station) as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include transmitting, to the UE, a third signaling as a reporting configuration of a request to indicate a polarization capability of the UE. The operations of 802 may be performed in accordance with examples as described herein. In some implementations, aspects of the operations of 802 may be performed by a device as described with reference to FIG. 1.

At 804, the method may include receiving, from the UE, a third signaling as an indication of a polarization type used for uplink resources in UCI or in uplink MAC CE. The operations of 804 may be performed in accordance with examples as described herein. In some implementations, aspects of the operations of 804 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
transmit one or more polarization parameters for signal reception and signal transmission;
receive a configuration for uplink reference signals, the configuration including an association of time and frequency resources with at least one polarization type based at least in part on the one or more polarization parameters; and
transmit the uplink reference signals according to the configuration.

2. The UE of claim 1, wherein the at least one processor is operable to cause the UE to receive a reporting configuration of a request to indicate a polarization capability of the UE.

3. The UE of claim 1, wherein the one or more polarization parameters includes at least one of a polarization type support, polarization related to a number of antennas, a polarization switching capability, or a polarization switching delay.

4. The UE of claim 3, wherein the polarization type support includes an indication of one or more polarization types, including at least one of linear polarization, right-hand circular polarization (RHCP), or left-hand circular polarization (LHCP) that is supported by the UE.

5. The UE of claim 1, wherein the one or more polarization parameters are transmitted in an apparatus capability exchange with a network entity (NE).

6. The UE of claim 1, wherein the configuration includes a mapping of resources for the uplink reference signals in a time, frequency, and polarization domain.

7. The UE of claim 1, wherein the configuration indicates a single polarization type for multiple sounding reference signals (SRSs) included in a resource set.

8. The UE of claim 1, wherein the configuration indicates configured resources for the uplink reference signals using spatial relation information, and the configuration includes an indication of a polarization type of a downlink source reference signal.

9. The UE of claim 1, wherein the at least one processor is operable to cause the UE to transmit an indication of a polarization type used for uplink resources in uplink control information (UCI) or in uplink medium access control-control element (MAC-CE).

10. The UE of claim 1, wherein the configuration indicates a repeating uplink reference signal with multiple polarizations.

11. The UE of claim 1, wherein the configuration includes a first association of the time and frequency resources with a polarization type for a first type of the uplink reference signals, and includes a second association of the time and frequency resources with a different polarization type for a second type of the uplink reference signals.

12. The UE of claim 1, wherein the configuration includes a polarization type associated with a sounding reference signal (SRS) for positioning measurements.

13. (canceled)

14. A network entity (NE) for wireless communication, comprising:
at least one memory; and
at least one processor coupled with the at least one memory and operable to cause the NE to:
receive one or more polarization parameters for signal reception and signal transmission; and
transmit a configuration for uplink reference signals, the configuration including an association of time and frequency resources with at least one polarization type based at least in part on the one or more polarization parameters.

15. The NE of claim 14, wherein the at least one processor is operable to cause the NE to transmit a reporting configuration of a request to indicate a polarization capability of a user equipment (UE).

16. The NE of claim 14, wherein the one or more polarization parameters includes at least one of a polarization type support, polarization related to a number of antennas, a polarization switching capability, or a polarization switching delay.

17. The NE of claim 16, wherein the polarization type support includes an indication of one or more polarization types, including at least one of linear polarization, right-hand circular polarization (RHCP), or left-hand circular polarization (LHCP) that is supported by the NE.

18. The NE of claim 14, wherein the one or more polarization parameters are transmitted in an apparatus capability exchange with a user equipment (UE).

19. The NE of claim 14, wherein the configuration includes a mapping of resources for the uplink reference signals in a time, frequency, and polarization domain.

20. A method performed by a user equipment (UE), the method comprising:
transmitting including one or more polarization parameters for signal reception and signal transmission;
receiving a configuration for uplink reference signals, the configuration including an association of time and frequency resources with at least one polarization type based at least in part on the one or more polarization parameters; and
transmitting the uplink reference signals according to the configuration.

21. A method performed by a network equipment (NE), the method comprising:
receiving one or more polarization parameters for signal reception and signal transmission; and
transmitting a configuration for uplink reference signals, the configuration including an association of time and frequency resources with at least one polarization type based at least in part on the one or more polarization parameters.
